(19) United States
(12) Patent Application Publication
(10) Pub. No.: US 2020/0226275 A1
(43) Pub. Date: Jul. 16, 2020

(54) ACTIVATING OR DEACTIVATING A FEATURE OF A VEHICLE

(71) Applicant: Infineon Technologies AG, Neubiberg (DE)

(72) Inventor: Florian Schreiner, Muenchen (DE)

(21) Appl. No.: 16/738,106

(22) Filed: Jan. 9, 2020

(30) Foreign Application Priority Data
Jan. 10, 2019 (DE) 102019100546.9

(51) Int. Cl. G06F 21/62; G06F 21/60

(52) U.S. Cl. CPC G06F 21/629; G05D 1/0088; G06F 21/602

(57) ABSTRACT

A device for activating or deactivating at least one feature in a vehicle, wherein the device is arranged to receive an information about the feature; to update an access control policy based on the information about the feature; and to provide an indication to a controller to activate or deactivate the feature based on the access control policy after the controller has been checked.

### TECHNICAL FIELD

Embodiments of the present disclosure relate to an activation or deactivation of (additional) features in a vehicle.

### BACKGROUND

It is known that additional features can be activated remotely in a car.

### SUMMARY

An objective is to improve existing solutions and in particular maintain or even improve the safety and/or security requirements of an automotive application.

The examples suggested herein may in particular be based on at least one of the following solutions. Combinations of the following features may be utilized to reach a desired result. The features of the method could be combined with any feature(s) of the device, apparatus or system or vice versa.

A device is provided utilized for activating or deactivating at least one feature in a vehicle, wherein the device is arranged

to receive an information about the feature;

to update an access control policy based on the information about the feature; and

to provide an indication to a control unit to activate or deactivate the feature based on the access control policy after the control unit has been checked.

The device may be realized as an authorization key module. It may be arranged and hardened to store keys and perform cryptographic operations.

Checking the control unit may comprise validating the identity of the control unit. This may comprise a unilateral or a bilateral authentication between the control unit and the device. The control unit may be an electronic control unit of the vehicle.

The vehicle may in particular be a car.

The activation or deactivation may be at least partially triggered remotely, i.e. via a wireless link to the vehicle.

According to an embodiment, the feature is at least one of the following: an autonomous driving function or feature, a multimedia service, a gaming service, an information service, at least one engine parameter, at least one parameter regarding the drivetrain, or a feature of a car that can be remotely activated or deactivated.

According to an embodiment, the information about the feature comprises at least one feature to be activated and/or at least one feature to be deactivated.

According to an embodiment, the information about the feature is transmitted from a feature manager to the device via an encrypted message.

According to an embodiment, the information about the feature is transmitted from the feature manager to the device after the feature manager has been authenticated with the device.

According to an embodiment, the access control policy indicates whether a feature is to be activated or deactivated.

According to an embodiment, the access control policy is stored or updated in the device.

According to an embodiment, the indication to activate or deactivate the feature provided to the control unit comprises a key, a derived key or any access information.

According to an embodiment, the control unit is an electronic control unit of the vehicle, in particular comprising an application processor that is arranged to execute or utilize the feature if the feature has been activated via the device.

According to an embodiment, checking the control unit comprises authenticating the control unit with the device.

According to an embodiment, the indication to activate or deactivate the feature is provided to the control unit via an encrypted message.

Also, a system of a vehicle is provided comprising an authorization key module and a control unit,

wherein the authorization key module is arranged
to receive an information about the feature;
to update an access control policy based on the information about the feature; and
to provide an indication to the control unit to activate or deactivate the feature based on the access control policy after the control unit has been checked; and
activating or deactivating the feature by the control unit based on the indication.

According to an embodiment, the information about the feature is provided by a feature manager via a wireless link, in particular a telecommunication link.

According to an embodiment, the authorization key module and the control unit are integrated in a module of the vehicle.

Further, a vehicle is suggested comprising at least one device as described herein or at least one system as described herein.

In addition, a method is suggested for processing feature information in a vehicle comprising:

receiving an information about the feature;

updating an access control policy based on the information about the feature; and

providing an indication to a control unit to activate or deactivate the feature based on the access control policy after the control unit has been checked.

According to an embodiment, the information about the feature is received from a feature manager via an encrypted message.

According to an embodiment, the method is run on an authorization key module.

Also, a device is provided for processing feature information in a vehicle comprising:

means for receiving an information about the feature;

means for updating an access control policy based on the information about the feature; and

means for providing an indication to a control unit to activate or deactivate the feature based on the access control policy after the control unit has been checked.

A computer program product is provided, which is directly loadable into a memory of a digital processing device, comprising software code portions for performing the steps of the method as described herein.

### BRIEF DESCRIPTION OF THE FIGURES

Embodiments are shown and illustrated with reference to the drawings. The drawings serve to illustrate the basic principle, so that only aspects necessary for understanding the basic principle are illustrated. The drawings are not to scale. In the drawings the same reference characters denote like features.

FIG. 1 shows a schematic diagram depicting a feature manager, an authorization key module and an ECU;

FIG. 2 shows a schematic message diagram between the feature manager and the authorization key module; and

FIG. 3 shows a schematic message diagram between the ECU and the authorization key module.

### DETAILED DESCRIPTION

In the automotive field, the user experience with modern vehicles is enhanced in particular by providing services that (e.g., temporarily) activate at least one additional feature. Such feature may be or comprise, e.g., an autonomous driving function, a multimedia service like music streaming, gaming, an information service, enhanced engine parameters or the like.

Such utilization of features needs to be protected by cryptographic methods in combination with an authorization mechanism that ensures that a request for the feature can be validated.

Existing electronic control units (ECUs) of a vehicle may have limited security, because additional security would increase the complexity of the ECU which may hence increase its error susceptibility. Therefore, it may be a general motivation to not increase the complexity of an ECU to meet the demand of cryptographic requirements.

Approaches described herein in particular suggest providing and utilizing an authorization key module as a dedicated component to enhance the security capability in a vehicle. Such authorization key module may be arranged to allow activating additional features in a secured environment.

The authorization key module provides functionalities to store keys and to perform cryptographic operations. Also, the authorization key module may contain an authorization engine that is capable of authenticating a remote entity and/or an ECU and of assigning an authorization mechanisms utilizing cryptographic keys.

The authorization key module may be a component that is provided separate to the ECU or it may be a part of the ECU.

A feature activation process may comprise the following steps utilizing the authorization key module:

(1) Authentication of a feature manager: The feature manager is a component that is allowed to activate a feature in the vehicle. The feature manager may be a component that is located in the backend. It may connect to the car via a wireless link (e.g., a telecommunication link). A user may buy a feature by using, e.g., an Internet platform. The feature manager then triggers the vehicle to activate (unlock) this feature. Hence, the feature manager connects to the authorization key module and performs an authentication. After the successful authentication, the authorization key module allows the feature manager to change the authorization mechanisms of keys stored in the authorization key module. After that the feature is activated and can be used.

(2) Using of activated feature: When the vehicle is used, the ECU may connect to the authorization key module and request a key that allows access to the feature. Also, a session between the authorization key module and the ECU may be established that ensures that the ECU is authenticated and that the communication exchanged in this session is encrypted. This can be facilitated by using a session key.

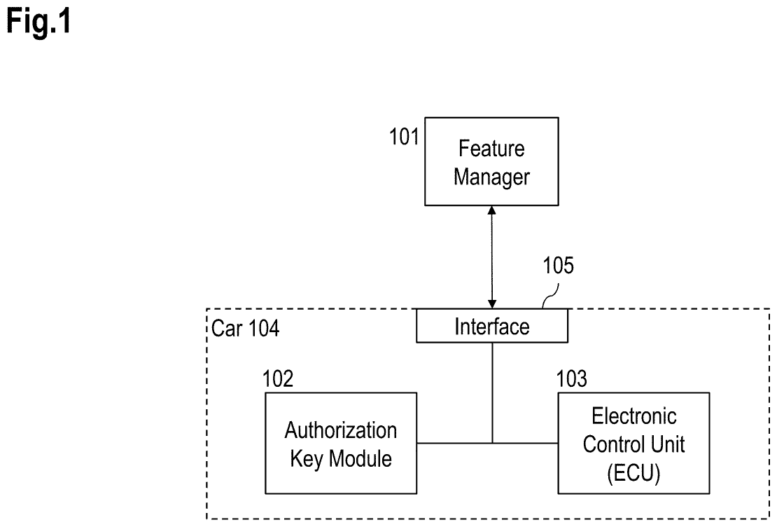

FIG. 1 shows a schematic diagram depicting a feature manager 101, an authorization key module 102 and an ECU 103. The authorization key module 102 and the ECU 103 are placed in a car 104. The car 104 comprises an interface 105 that allows data communication of the authorization key module 102 or the ECU 103 with the feature manager 101. Also, the authorization key module 102 and the ECU 103 are arranged to communicate with each other, e.g., via a bus system.

The ECU 103 comprises an application CPU that runs software that may or may not enable features depending on whether they have been activated or not.

The feature manager 101 may be run by a vendor or a car manufacturer to allow a user to book or buy features that are then activated in the car 104.

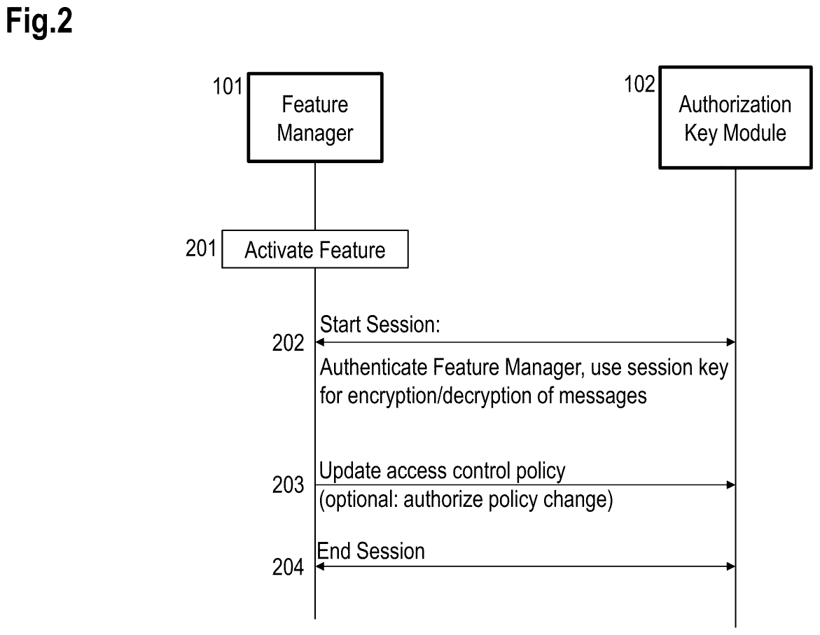

FIG. 2 shows a schematic message diagram between the feature manager 101 and the authorization key module 102.

In a step 201, a feature, e.g., a multimedia feature or a comfort driving feature is unlocked by a user. In this exemplary case, the user wants to add the feature to his car and therefore pays a predetermined amount of money to have it available in the car as soon as he next time enters his car. The feature manager 101 hence acts as interface between the user and the vendor or car manufacturer and triggers unlocking said feature in the electronic control unit 103 of the car.

To make this happen, in a step 202 a session is initiated between the feature manager 101 and the authorization key module 102. The session authenticates the feature manager 101 and allows using a session key for encryption/decryption purposes. Hence, messages between the feature manager 101 and the authorization key module 102 can be encrypted using this session key.

In a step 203, the feature manager 101 initiates an update of an access control policy. The access control policy is stored at the authorization key module 102 and defines which features are locked and which features are unlocked for this particular car.

Hence, the feature manager 101 updates the access control policy of the authorization key module 102 which sets the feature that has been bought by the user to a status “active”. In order to avoid that any attacker or any component other than the entitled feature manager 101 activates the feature, the feature manager 101 has to be authenticated as stated above. In addition, it might be an option that the feature manager 101 has to authorize the policy change before being allowed to update the access control policy. Such authorization of the policy change may be realized by sending a password from the feature manager 101 to the authorization key module 102. After the authorization key module 102 has validated the password, it is susceptible for receiving information to update of the access control policy from this very feature manager 101 (which as such has been authenticated before). If the password is not correct, the feature manager 101 will not be able to update the access control policy of the authorization key module 102. Hence, the feature will not be updated (in this example activated).

It is also an option that a successful update is indicated by a message sent from the authorization key module 102 to the feature manager 101.

In a step 204, the session ends. Now, the access control policy of the authorization key module 102 has been successfully updated (or not) such that the feature could (or not) be used when the car is (re-)activated.

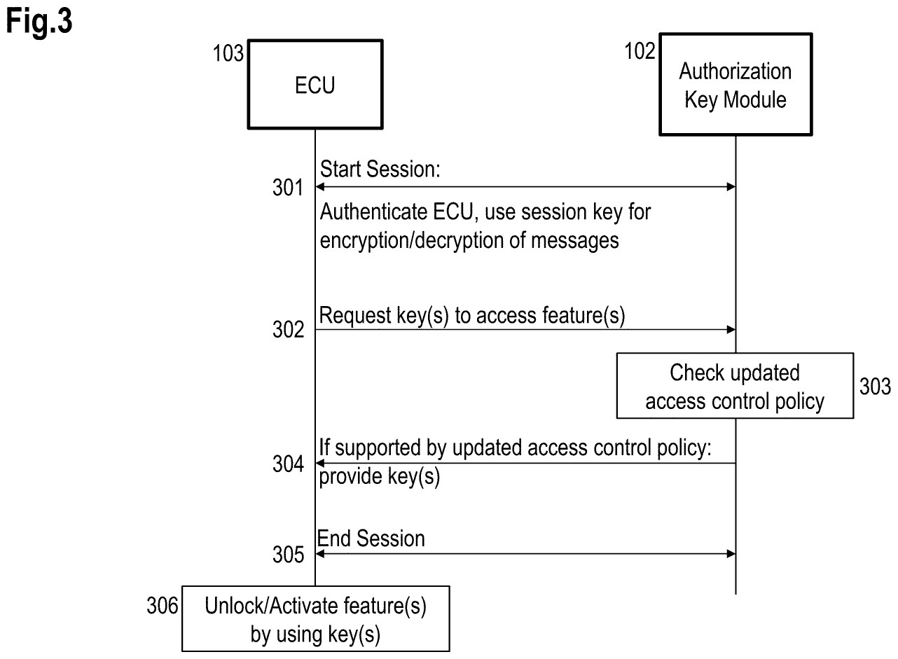

FIG. 3 shows a schematic message diagram between the ECU 103 and the authorization key module 102. This diagram refers to steps that may occur after the update of the access control policy of the authorization key module 102 as shown in FIG. 2.

Several events may trigger the steps shown in FIG. 3. In one example, the user wants to activate or drive his car and enjoy the feature he previously bought. In another example, the steps shown in FIG. 3 may be autonomously conducted by the car at a regular or irregular time interval to become aware of potentially activated features. The steps shown in FIG. 3 may be run when the car is in a standby mode or in an active mode. It is an option that some features can only be activated when the car is in a predetermined state or mode; this in particular refers to features that are safety-relevant or impact the driving characteristics of the car.

In a step 301, a session is initiated between the ECU 103 and the authorization key module 102. The session authenticates the ECU 103 and allows using a session key for encryption/decryption purposes. Hence, messages between the ECU 103 and the authorization key module 102 can be encrypted using this session key.

In order to access the feature, the ECU 103 requires a key. In a step 302, a key request is submitted from the ECU 103 to the authorization key module 102. In a step 303, the authorization key module 102 checks the updated access control policy and in a step 304 provides the key(s) to the feature(s) only in case the updated access control policy indicates that this/these features shall be accessible. If there is no feature unlocked according to the information available in the (updated) access control policy, no such keys are transmitted from the authorization key module 102 to the ECU 103.

In a step 305, the session may end.

In a step 306, the feature is activated by the ECU 103 by using the key obtained from the authorization key module 102.

It is an option that the step 305 is executed after the step 306. The session is maintained between the steps 301 and 305. As explained above, the session may use the session key to ensure that any communication between the ECU 103 and the authorization key module 102 is encrypted.

It is also an option that the key may be any sort of feature information. Hence, in the step 302 a feature-specific information may be provided from the ECU 103 to the authorization key module 102. Step 303 may then be executed in particular based on this feature-specific information. Step 304 may convey any access information and/or derived key instead of a key that is to be kept secret within the authorization key module 102.

There are several alternative embodiments for the ECU 103 and/or the authorization key module 102 to become aware of additional feature(s) to be activated. One example is that the ECU 103 at regular or irregular time intervals or events (like every n-th start of the car) transmits as the request 302 a message that asks for the keys of all currently unlocked features.

As an alternative, the ECU 103 may be provided in advance, via, e.g., the feature manager 101 or the authorization key module 102 with information about additional features that could be activated. In order to get them activated, the ECU 103 then as the request 302 sends a message asking for the additional features it wants to activate.

It is noted that the request 302 may be a dedicated request directed to a key to one particular feature or as a request directed to several keys to several features or a request directed to any features for which keys are available in the (updated) access control policy.

It is further noted that the request 302 may also be or comprise a request for a derived key or any token that allows the ECU 103—after having received the derived key or token—to activate the feature(s) that is/are associated with it.

It is also an option that a single key or a single derived key (or token) may be used to activate more than one feature.

Also, a feature once activated may expire after a predetermined amount of time. For example, a user may subscribe to a multimedia feature for a duration of, e.g., one year. After this duration and without a renewal of the subscription, the feature should become inactive. This can be achieved via the feature manager 101 (according to FIG. 2) initiating an update of the access control policy thereby deactivating the feature. In a subsequent communication between the ECU 103 and the authorization key module 102, the authorization key module 102 may actively inform the ECU 103 about the feature that is no longer available and the ECU 103 blocks this feature.

As an alternative (or in addition), a feature that should only be active for a predefined amount of time may be known to ECU 103 and/or the authorization key module 102 when being activated for the first time thereby setting a timer or a time stamp (end-of-duration); after the timer has run out (or the end-of-duration is reached), the key to activate this feature is no longer valid or the key to this feature is no longer supplied by the authorization key module 102. This approach may be favorable in case the mechanism shown in FIG. 3 runs on a regular basis thereby re-confirming the keys provided by the authorization key module 102; hence, the authorization key module 102 no longer providing a (valid) key for a feature to be confirmed leads to the deactivation of this feature by the ECU 103.

It is yet another option that the ECU 103 has to authorize any key usage with the authorization key module 102 by, e.g., sending a password to the authorization key module 102. After the authorization key module 102 has validated the password, it is susceptible for receiving the request 302. If the password is not correct, the ECU 103 will not obtain any keys.

Advantages and further aspects

Advantageously, according to the examples described herein, an authorization is transferred to the authorization key module, which acts as a protected and secured environment. There may even be a special key store within the authorization key module that is utilized for the purpose of this approach. The authorization key module is able to validate the feature manager and/or the ECU and to establish a bilateral connection with the feature manager and/or the ECU. Preferably, cryptographic operations are executed within the authorization key module.

It is an option to send the key from the authorization key module to the ECU or to send a derived key so that the original key may remain hidden within the authorization key module.

It is noted that the session keys referred to above (see step 202 in FIG. 2 and step 301 in FIG. 3) may be a derived key from a Diffie-Hellman protocol. The session key may be used to encrypt the communication (e.g., command and response) between the respective components.

The authentication of the authorization key module 102 in FIG. 2 may be performed using an authentication key of the authentication key module thereby achieving a one-sided authentication. This may apply accordingly for the authentication of the ECU 103 in FIG. 3.

Hence, proposals described herein enhance a system architecture by including a secured and dedicated authorization key module. The security functionality for feature activation (and deactivation) is thereby migrated to the protected authorization key module. This authorization key module can be security-hardened against potential attacks.

It is also an advantage that the authorization key module can be integrated in existing solutions, in particular vehicle environments.

It is noted that the ECU described herein may be an application processor or it may be a control component comprising such application processor. It is another option that the ECU and the authorization key module are integrated in the same module. It is yet an option that the ECU further comprises at least one of the following: a microcontroller, a bus system, an Ethernet interface, a memory.

In one or more examples, the functions described herein may be implemented at least partially in hardware, such as specific hardware components or a processor. More generally, the techniques may be implemented in hardware, processors, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium, i.e., a computer-readable transmission medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more central processing units (CPU), digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a single hardware unit or provided by a collection of interoperative hardware units, including one or more processors as described above, in conjunction with suitable software and/or firmware.

Although various exemplary embodiments of the disclosure have been disclosed, it will be apparent to those skilled in the art that various changes and modifications can be made which will achieve some of the advantages of the disclosure without departing from the spirit and scope of the disclosure. It will be obvious to those reasonably skilled in the art that other components performing the same functions may be suitably substituted. It should be mentioned that features explained with reference to a specific figure may be combined with features of other figures, even in those cases in which this has not explicitly been mentioned. Further, the methods of the disclosure may be achieved in either all software implementations, using the appropriate processor instructions, or in hybrid implementations that utilize a combination of hardware logic and software logic to achieve the same results. Such modifications to the inventive concept are intended to be covered by the appended claims.

1. A device for activating or deactivating at least one feature in a vehicle, wherein the device is configured:
to receive an information about the feature;
to update an access control policy based on the information about the feature; and
to provide an indication to a controller to activate or deactivate the feature based on the access control policy after the controller has been checked.

2. The device according to claim 1, wherein the feature is at least one of the following:
an autonomous driving function or feature, a multimedia service, a gaming service, an information service, at least one engine parameter, at least one parameter regarding the drivetrain, or a feature of a car that can be remotely activated or deactivated.

3. The device according to claim 1, wherein the information about the feature comprises at least one feature to be activated or at least one feature to be deactivated.

4. The device according claim 1, wherein the information about the feature is transmitted from a feature manager to the device via an encrypted message.

5. The device according to claim 4, wherein the information about the feature is transmitted from the feature manager to the device after the feature manager has been authenticated with the device.

6. The device according to claim 1, wherein the access control policy indicates whether a feature is to be activated or deactivated.

7. The device according to claim 1, wherein the access control policy is stored or updated in the device.

8. The device according to claim 1, wherein the indication to activate or deactivate the feature provided to the controller comprises a key, a derived key, or any access information.

9. The device according to claim 1, wherein the controller is an electronic controller of the vehicle comprising an application processor that is arranged to execute or use the feature if the feature has been activated via the device.

10. The device according to claim 1, wherein checking the controller comprises authenticating the controller with the device.

11. The device according to claim 1, wherein the indication to activate or deactivate the feature is provided to the controller via an encrypted message.

12. A system of a vehicle, comprising:
an authorization key module, wherein the authorization key module is arranged:
to receive an information about the feature;
to update an access control policy based on the information about the feature; and
to provide an indication to the controller to activate or deactivate the feature based on the access control policy after the controller has been checked; and
a controller configured to activate or deactivate the feature based on the indication.

13. The system according to claim 12, wherein the information about the feature is provided by a feature manager via a wireless telecommunication link.

14. The system according to claim 12, wherein the authorization key module and the controller are integrated in a module of the vehicle.

15. A vehicle comprising at least one device according to claim 1.

16. A method for processing feature information in a vehicle, the method comprising:
receiving an information about the feature;
updating an access control policy based on the information about the feature; and
providing an indication to a controller to activate or deactivate the feature based on the access control policy after the controller has been checked.

17. The method according to claim 16, wherein the information about the feature is received from a feature manager via an encrypted message.

18. The method according to claim 16, wherein the method is run on an authorization key module.

19. A device for processing feature information in a vehicle, comprising:
means for receiving an information about the feature;
means for updating an access control policy based on the information about the feature; and
means for providing an indication to a controller to activate or deactivate the feature based on the access control policy after the controller has been checked.

20. A non-transitory computer program product directly loadable into a memory of a digital processor, comprising software code portions for performing the steps of the method according to claim 16.
